(19) United States
(12) Patent Application Publication
(10) Pub. No.: US 2024/0293895 A1
(43) Pub. Date: Sep. 5, 2024

(54) FIREARM COLOR LASER ETCHING SYSTEMS AND METHODS

(71) Applicant: William Cecil Reynolds, Jr., Winter Haven, FL (US)

(72) Inventor: William Cecil Reynolds, Jr., Winter Haven, FL (US)

(21) Appl. No.: 18/469,551

(22) Filed: Sep. 18, 2023

Related U.S. Application Data
(60) Provisional application No. 63/407,619, filed on Sep. 16, 2022.

(51) Int. Cl. B23K 26/362; B23K 26/402; B44C 1/22

(52) U.S. Cl. CPC B23K 26/362; B23K 26/402; B44C 1/228

(57) ABSTRACT

Methods, system, and computer readable media for etching polymer firearm components with different shades are described.

### TECHNICAL FIELD

Embodiments relate generally to etching equipment, and more particularly, to methods, systems and computer readable media for color laser etching on polymer components of firearms or other polymer components.

### BACKGROUND

Firearms often have polymer components such as grips. Firearm users may desire a specific pattern in the polymer components for aesthetic purposes or utility purposes (e.g., camouflage). Thus, a need may exist for etching polymer components of a firearm or polymer components of other objects.

Some implementations were conceived in light of the above-mentioned needs, problems and/or limitations, among other things. The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

FIG. 1 shows a polymer color laser etching system in accordance with some implementations.

FIG. 2 is a flowchart showing an example method of polymer color laser etching system in accordance with some implementations.

FIGS. 3-6 are diagrams of example firearm grips that have been color laser etched using the system and techniques described herein.

FIG. 7 is a diagram of an example computing device configured for electronic employment document control in accordance with at least one implementation.

### DETAILED DESCRIPTION

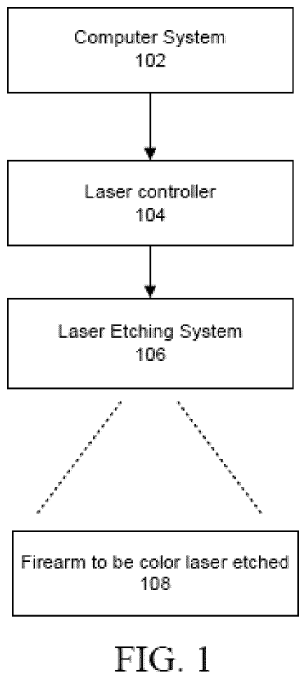

FIG. 1 shows a polymer color laser etching system in accordance with some implementations. The color laser etching system includes a computer system 102 coupled to a laser controller 104, which is coupled to a laser etching system 106. It will be appreciated that the computer system 102, the laser controller 104, and the laser etching system 106 can be separate devices or integrated into one or more integrated devices.

In operation the computer system 102, the laser controller 104, and the laser etching system 106 operate together to color laser etch a firearm 108 as discussed below in greater detail.

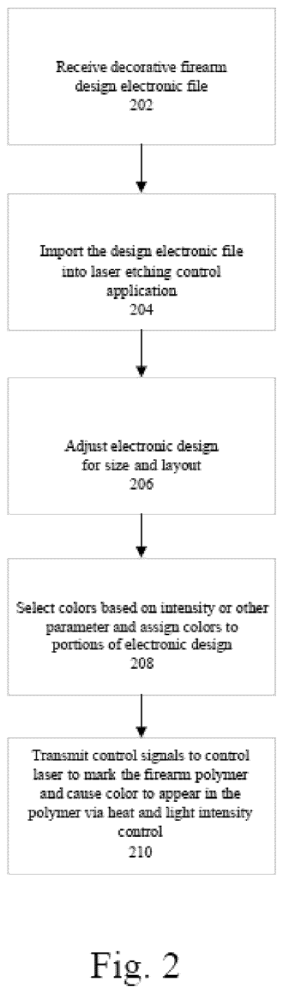

FIG. 2 is a flowchart showing an example method of polymer color laser etching system in accordance with some implementations. Processing begins at 202, where a decorative firearm design electronic file is received. The file or data can be received from a computer readable storage device, an external system, created in a component of the color laser etching system (e.g., 102, 104, and/or 106), Processing continues to 204.

At 204, the electronic design file is imported into a laser etching control application. Processing continues to 206.

At 206, the size and layout of the electronic design is optionally adjusted. Processing continues to 208.

At 208, colors for the design elements are selected based on the intensity or other parameter and the colors are assigned to portions of the electronic design. Processing continues to 210.

At 210, an electronic control signal representing the design (including changes in intensity or other parameter to etch colors) to control a laser is transmitted to the laser etching system (e.g., a system manufactured by LaserStar Technologies Corporation of Orlando Florida or other suitable system) to etch the firearm polymer components or other polymer component. The different colors can be achieved by varying a parameter of the laser etching system such as the intensity of the laser (e.g., laser power output, where various power settings produce different colors in the etched polymer), time spent etching a given portion (e.g., where the laser dwelling for different time periods over given portions produces different colors), number of passes with the laser at a given portion (e.g., where number of passes may produce a different color), laser frequency (either light frequency or pulse frequency), or other suitable parameter or parameters. In some implementations, the parameters can control one or more of line spacing (e.g., distance between lines being etched by the laser), output power of the laser, laser frequency, speed and pulse width to create different colors and tone of etched polymer products.

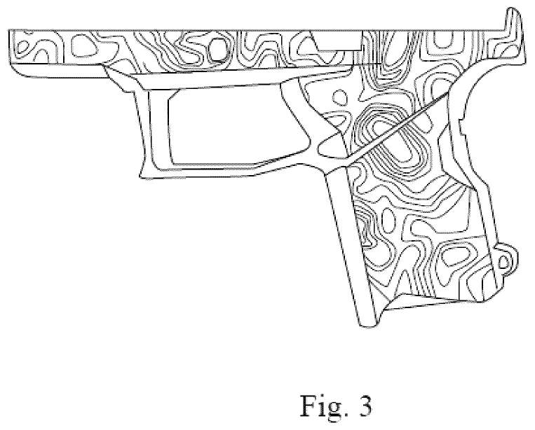

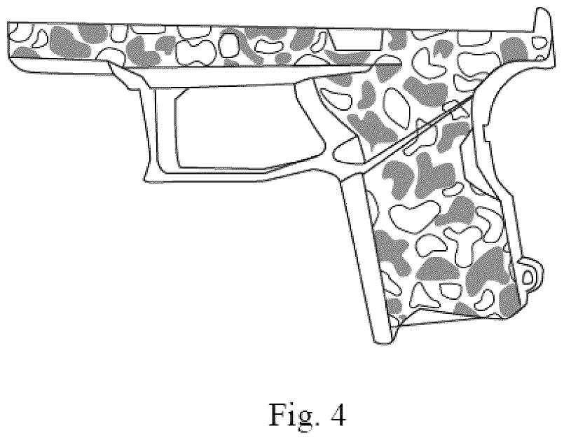

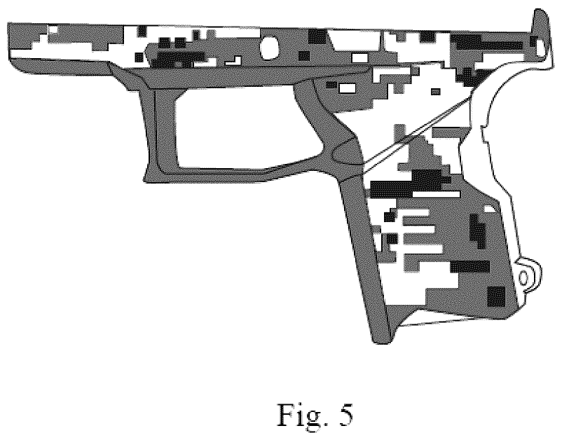

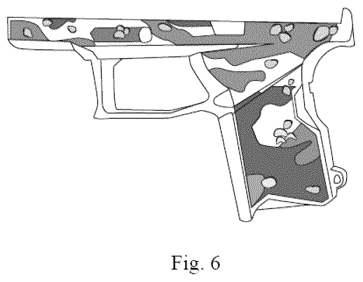

FIGS. 3-6 are diagrams of example firearm grips that have been color laser etched using the system and techniques described herein. FIG. 3 shows a single-color design pattern laser etched into a polymer component of a firearm. FIG. 4 shows an example two-color design pattern laser etched into a polymer component of a firearm. FIG. 5 shows an example three-color design pattern laser etched into a polymer component of a firearm. FIG. 6 shows an example four-color design pattern laser etched into a polymer component of a firearm.

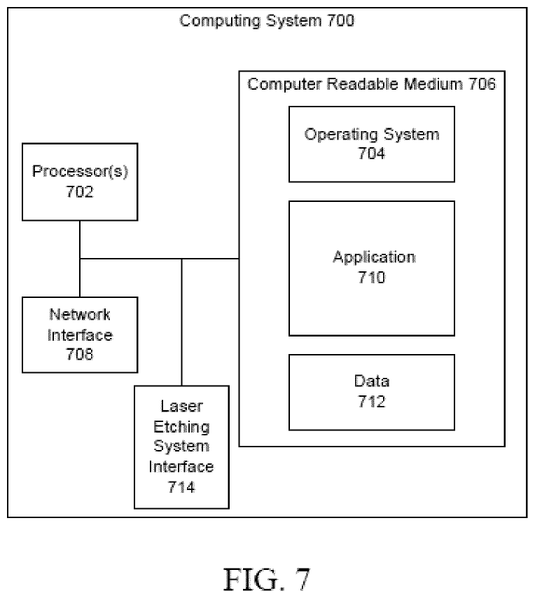

FIG. 7 is a diagram of an example computing device 700 in accordance with at least one implementation. The computing device 700 includes one or more processors 702, nontransitory computer readable medium 706, network interface 708, and a laser etching system interface 714. The computer readable medium 706 can include an operating system 704, an application 710 for color laser polymer etching, a data section 712 (e.g., for storing electronic design pattern data, laser parameter to color mapping data, etc.), and a laser etching system interface 714.

In operation, the processor 702 may execute the application 710 stored in the computer readable medium 706. The application 710 can include software instructions that, when executed by the processor, cause the processor to perform operations to color laser polymer etching in accordance with the present disclosure (e.g., performing associated functions described above and shown in FIG. 2).

The application program 710 can operate in conjunction with the data section 712 and the operating system 704.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general-purpose computer, a special purpose computer, a microprocessor, a network server or switch, or the like.

It is, therefore, apparent that there is provided, in accordance with the various embodiments disclosed herein, methods, systems and computer readable media for color laser polymer etching on firearms or other products or components.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

What is claimed is:

1. A computer implemented method comprising:
receiving a decorative firearm design electronic file representing a design;
importing the electronic firearm design file into a laser etching control application;
selecting colors for elements of the design based on one of laser intensity or other laser control parameter;
assigning colors to corresponding portions of the design based on the selected colors; and
generating an electronic control signal representing the design, including changes in intensity or other parameter to etch colors, wherein the control signal is configured to control a laser etching system; and
transmitting the control signal to the laser etching system to etch one or more firearm polymer components with the design.
